(19) United States
(12) Patent Application Publication
(10) Pub. No.: US 2007/0236086 A1
(43) Pub. Date: Oct. 11, 2007

(54) Circuit board

(75) Inventor: Ayako Takagi, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/715,962

(22) Filed: Mar. 9, 2007

(30) Foreign Application Priority Data
Mar. 10, 2006 (JP) P2006-065192

(51) Int. Cl. H02J 3/00; H02J 1/10

(52) U.S. Cl. 307/11; 307/43

(57) ABSTRACT

A transmitter IC is disposed on a first substrate. The transmitter IC supplies a pair of differential signals. A pair of bus lines is disposed on the first substrate. The pair of bus lines has each connection to receive the pair of differential signals. A terminating register is disposed on the first substrate. The terminating register is electrically connected to one end of the pair of bus lines. N pairs of first branch lines are disposed on the first substrate. Each of the N pairs of first branch lines is branched from the pair of bus lines. N pairs of second branch lines are disposed on a second substrate. Each of the N pairs of second branch lines is electrically connected to each of the N pairs of first branch lines. N units of receiver ICs are disposed on a third substrate. Each of the N units of receiver ICs is electrically connected to each of the N pairs of second branch lines. Relationship between a common mode impedance Z1 of the first branch lines and a common mode impedance Z2 of the second branch lines is 0.8·Z1≦Z2≦1.2·Z1.

### CROSS-REFERENCE TO RELATED APPLICATIONS

This application is based upon and claims the benefit of priority from prior Japanese Patent Application No. 2006-065192, filed on Mar. 10, 2006; the entire contents of which are incorporated herein by reference.

### FIELD OF THE INVENTION

The present invention relates to a circuit board having a plurality of branch lines to supply a differential signal.

### BACKGROUND OF THE INVENTION

Recently, data processed by a personal computer have a large quantity such as a high resolution image, and improvement of processing ability is desired. Accordingly, a clock frequency of a CPU is sampled at high speed, and a bus line, a clock line, and a data line to peripheral ICs are laid at high density. As a result, unnecessary radiation noise, i.e., EMI (Electro Magnetic Interference) becomes an issue.

Furthermore, in a digital device, a harmonic element of the clock signal and the data signal directly cause unnecessary field noise and a conductive emission. When a high frequency current caused by such signal flows into a wire, a print board or a body in the system, (unintentional) field characteristic of an antenna also causes unnecessary field noise. In order to solve the EMI problem, elimination of the unnecessary field noise is desired.

In case of transferring data between a CPU and a plurality of memories or driving a display by an electronic device, one transmitter IC often drives a plurality of receiver ICs. In this case, a method for diverging (branching) one signal line to a plurality of branch lines is used. In the branch line, a signal is reflected at a divergent point of the branch line, and harmonic elements overlap. As a result, the harmonic noise may cause EMI.

Accordingly, as the branch line, a differential signal line (For example, RSDS (Reduced Swing Differential Signal) line to transmit a small amplitude differential line) is used to drive a LCD (Liquid Crystal Display). In this method, the EMI reduces because an electric field closes in a pair of differential signal lines. Furthermore, as a general method to reduce the EMI, a sealed ground is disposed on a circuit in order not to leak the electric field to outside. For example, a method for connecting the sealed ground to a substrate ground by through hole is disclosed in Japanese Patent Publication No. 2003-347692.

Briefly, in case of generating a common mode noise by unbalance of rise and fall of the signal at the differential signal line, a return current as a cause of the EMI flows to a ground surface. In this case, the common mode noise from each branch line overlaps, and the EMI often increases.

### SUMMARY OF THE INVENTION

The present invention is directed to a circuit board having a plurality of branch lines able to reduce a field noise.

According to an aspect of the present invention, there is provided a circuit board comprising a first substrate, a second substrate, and a third substrate; the first substrate comprising: a transmitter IC supplying a pair of differential signals; a pair of bus lines each having a connection to receive the pair of differential signals; a terminating register electrically connected to one end of the pair of bus lines; and N pairs of first branch lines, each of the N pairs of first branch lines being branched from the pair of bus lines; the second substrate comprising: N pairs of second branch lines, each of the N pairs of second branch lines electrically connected to each of the N pairs of first branch lines; and the third substrate comprising: N units of receiver ICs, each of the N units of receiver ICs electrically connected to each of the N pairs of second branch lines; wherein relationship between a common mode impedance Z1 of the first branch lines and a common mode impedance Z2 of the second branch lines is 0.8·Z1≦Z2≦1.2·Z1.

### BRIEF DESCRIPTION OF THE DRAWINGS

FIG. 1 is a plan view of a circuit board according to a first embodiment of the present invention.

FIGS. 2A, 2B, and 2C are plan views of three insulator layers of a first circuit board in FIG. 1.

FIGS. 3A, 3B, and 3C are cross-sectional views of the circuit board in FIG. 1.

FIG. 4 is an equivalent circuit model of the circuit board in FIG. 1.

FIG. 5 is a plan view of a circuit board of a comparative example.

FIGS. 6A, 6B, and 6C are plan views of three insulator layers of a first circuit board in FIG. 5.

FIGS. 7A, 7B, and 7C are cross-sectional views of the circuit board in FIG. 5.

FIG. 8 is a plan view of a circuit board with a high frequency current on a ground electrode layer according to the first embodiment of the present invention.

FIG. 9 is a plan view of a circuit board with a high frequency current on a ground electrode layer according to a comparative example.

FIG. 10 is a graph representing a frequency dependency of horizontal element of field strength of the first embodiment and the comparative example.

FIG. 11 is a graph representing a frequency dependency of vertical element of field strength of the first embodiment and the comparative example.

FIG. 12 is a plan view of a circuit board according to a first modification of the present invention.

FIG. 13 is a plan view of a circuit board according to a second modification of the present invention.

FIGS. 14A, 14B, and 14C are plan views of three insulator layers of a first circuit board in FIG. 13.

FIG. 15 is a cross-sectional view of a circuit board according to a second embodiment of the present invention.

FIGS. 16A, 16B, and 16C are plan views of three insulator layers of a first circuit board in FIG. 15.

FIGS. 17A, 17B, and 17C are plan views of three insulator layers of a first circuit board according to a third embodiment of the present invention.

FIG. 18 is a plan view of a meshed ground electrode layer compared with a multipoint line circuit.

FIG. 19 is a plan view of a circuit board according to a fourth embodiment of the present invention.

FIGS. 20A, 20B, and 20C are plan views of three insulator layers of a first circuit board in FIG. 19.

FIG. 21 is a plan view of a circuit board with a high frequency current on a ground electrode layer according to the fourth embodiment of the present invention.

### DETAILED DESCRIPTION OF THE EMBODIMENTS

Hereinafter, various embodiments of the present invention will be explained by referring to the drawings. The present invention is not limited to the following embodiments.

### First Embodiment

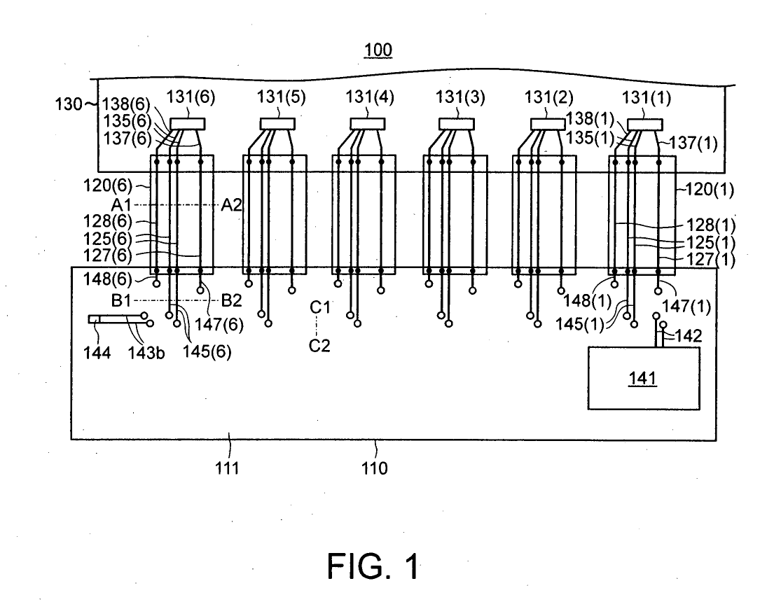

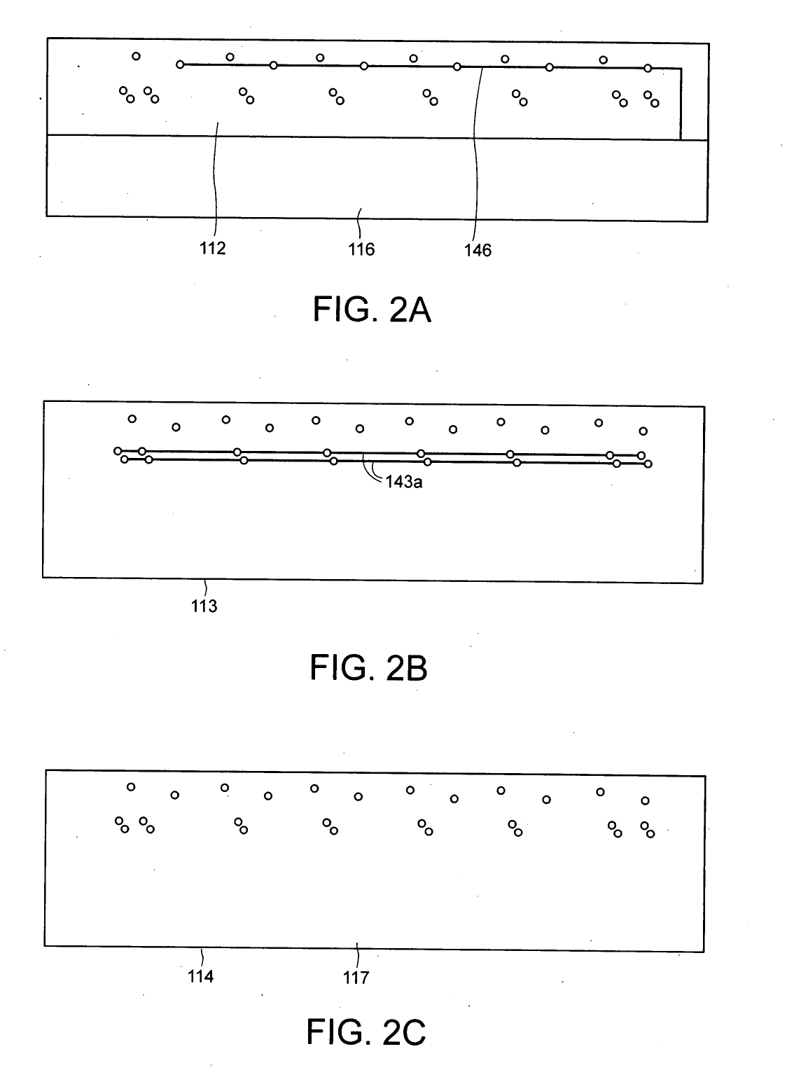

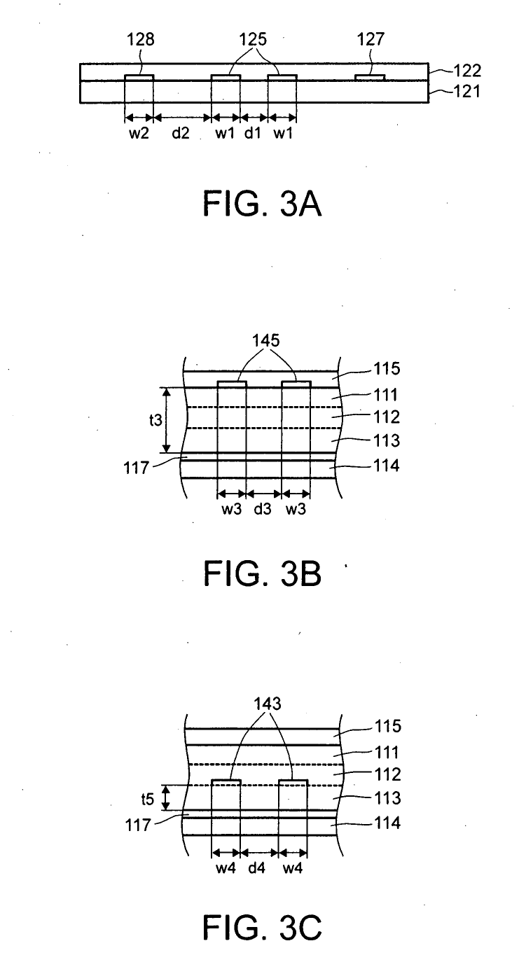

Hereinafter, a first embodiment is explained. FIG. 1 is a plan view of a circuit board 100 of the first embodiment. Especially, on a first substrate 110 and a second substrate 120, first insulator layers 111 and 122 are shown. FIGS. 2A, 2B, and 2C are plan views of a second insulator layer 112, a third insulator layer 113, and a fourth insulator layer 114. FIGS. 3A, 3B, and 3C are cross-sectional views of the circuit board 100 cut by A1-A2, B1-B2 and C1-C2 in FIG. 1, which represents a coplanar line, a micro strip line, and a strip line.

The circuit board 100 includes a first substrate 110, a second substrate 120 (120(1)˜120 (N)), and a third substrate 130. In this case, “N” represents the number of branches. In FIG. 1, “N” is 6. However, the number of branches is not limited to 6. Accordingly, hereinafter, the number of branches is represented as “N”.

For example, the first substrate 110 is a print substrate. As shown in FIGS. 1, 2A˜2C, and 3A˜3C, the first substrate 110 includes a first insulator layer 111, a second insulator layer 112, a third insulator layer 113, a fourth insulator layer 114, a protection layer 115, a power supply electrode layer (power supply face) 116, a ground electrode layer (ground face) 117, a driving-IC 141, a differential signal line 142, a differential signal bus line 143 (143a, 143b), a terminating register 144, a branch signal line 145 (145(1)˜145(N)), a power supply line 146, a branch power supply line 147 (147(1)˜147 (N)) and a ground line 148 (148(1)˜148(N)).

The first, second, third, and fourth insulator layers 111˜114 are used for multiple-disposing lines while maintaining isolation among layers. On the first insulator layer 111, a layer having the branch signal line 145, the branch power supply line 147, and the ground line 148 are disposed. On the second insulator layer 112, a layer having the power supply electrode layer 116 and the power supply line 146 are disposed. On the third insulator layer 113, a layer having the differential signal bus line 143a is disposed. On the fourth insulator layer 114, the ground electrode layer 117 is disposed. In this case, a layer having a signal line along a horizontal direction is different from a layer having a signal line along a vertical direction in order to prevent short by line cross.

The protection layer 115 protects lines (For example, the differential signal line 142, and the differential signal bus line 143b) on the first isolator layer 111 from the outside. The power supply electrode layer 116 is disposed on the second isolator layer 112 in order to supply an electric power to a receiver IC (explained afterwards). The power supply electrode layer 116 is not disposed under the differential signal lines (the differential signal bus line 143 and the branch signal line 145) in order to adjust common mode impedance on the first substrate 110.

The ground electrode layer 117 is disposed on the fourth insulator layer 114 in order to ground the receiver IC. Furthermore, the ground electrode layer 117 reduces the field from the branch signal line 145 by common mode noise. The ground electrode layer 117 is not always necessary to transmit signals because a pair of differential signal lines 145 transfers differential signals. However, common mode noise may be generated by unbalance of rise and fall of waveform. The common mode noise often causes a large field from a small current. Accordingly, the ground electrode layer 117 faces the branch signal line 145 in order to reduce the field.

The driving-IC 141 (transmitter IC) is disposed on the first insulator layer 111 in order to drive the receiver IC. The driving-IC 141 has an end to output a differential signal and functions as a differential signal output element. An output signal from the driving-IC 141 is, for example, a digital waveform based on a predetermined clock frequency. The differential signal line 142 is a pair of lines adjacently disposed in parallel. The differential signal line 142 is disposed on the first insulator layer 111 in order to connect the driving-IC 141 with the differential signal bus line 143a.

The differential signal bus line 143 (143a, 143b) is a pair of lines adjacently disposed in parallel, i.e., a bus line to transfer and diverge the differential signal to the branch signal line 145. The differential signal bus lines 143a and 143b are respectively disposed on the third insulator layer 113 and the first insulator layer 111, which are mutually connected by a through hole. In the first embodiment, as shown in FIGS. 1 and 2B, a connection point to connect the differential signal line 142 is on the right edge of the differential signal bus line 143a.

The terminating register 144 is disposed on the first insulator layer 111 and connected to the left edge of the differential signal bus line 143b as shown in FIG. 1. By terminating the differential signal bus line 143b, reflection of a signal at an edge part of the differential signal bus line 143 is reduced. As explained afterwards, if the differential signal line 142 is connected to the differential signal bus line 143 except for the edge part, the terminating register 144 is respectively disposed on both sides of the differential signal bus line line 143.

Branch signal bus lines 145 (145(1)˜145(N)) are disposed on the first insulator 111 as lines to connect the differential signal bus line 143 with the receiver IC 131. N pairs of the branch signal lines 145 are respectively disposed in correspondence with N pairs of differential input terminals.

The power supply line 146 is disposed on the second insulator layer 112 as a line to connect the power supply electrode layer 116 with the branch power supply line 147 as shown in FIG. 2A. The branch power supply line 147 (147(1)˜147 (N)) is disposed on the first insulator layer 111 as a line to connect the power supply line 146 with the receiver IC 131. N lines of the branch power supply line 147 are respectively disposed in correspondence with N units of the receiver IC 131. The ground line 148 (148(1)˜148(N)) is disposed on the first insulator layer 111 and connected to the ground electrode layer 117 by a through hall. The ground layer 148 connects the receiver IC 131 with the ground electrode layer 117.

The second substrate 120(1)˜120(N) is, for example, FPC (Flexible Printed Circuit) board, and has an insulator layer 121 and a protection layer 122 between which a branch signal lines 125 (125(1)˜125(N)), branch power supply lines 127 (127(1)˜127(N)), and ground lines 128 (128(1)˜128(N)) are disposed. The second substrate 120 does not have a ground electrode layer, which is different from the first substrate 110. If the second substrate 120 has a ground electrode layer, a thickness of the second substrate increases. As a result, the second substrate cannot be bent.

N pairs of branch signal lines 125 are respectively connected to N pairs of branch signal lines 145. A branch power supply line 127 electrically connects a branch power supply line 137 with the branch power supply line 147. A ground line 128 electrically connects a ground line 138 with the ground line 148.

The third substrate 130 is, for example, a glass substrate, on which a receiver IC 131 (131(1)˜131 (N)), a branch signal line 137 (137(1)˜137(N)), and a ground line 138 ((138(1)˜138(N)) are disposed.

The receiver IC 131 is, for example, a liquid driver IC, and implemented by COG (Chip on Glass) on the third substrate 130. COG is a method for directly implementing a semiconductor chip (the receiver IC 131) on the glass substrate (the third substrate 130).

The branch signal line 135 electrically connects the receiver IC 131 with the branch signal line 125. The branch power supply line 137 electrically connects the receiver IC 131 with the branch power supply line 127. The ground line 138 electrically connects the receiver IC 131 with the ground line 128.

A signal from the driving-IC 141 is transmitted to the receiver IC 131 via the differential signal bus line 143 and the branch signal line 145, 125 and 135. Then the signal is terminated at the ground electrode layer 117 via the ground line 138, 128 and 148.

The differential signal bus line 143 branches (diverged) to N pairs of branch signal lines 145 and 125 in correspondence with N units of receiver IC 131. Electric current flows based on characteristic impedance of the branch signal line 145 and 125.

(Equivalent Circuit Model)

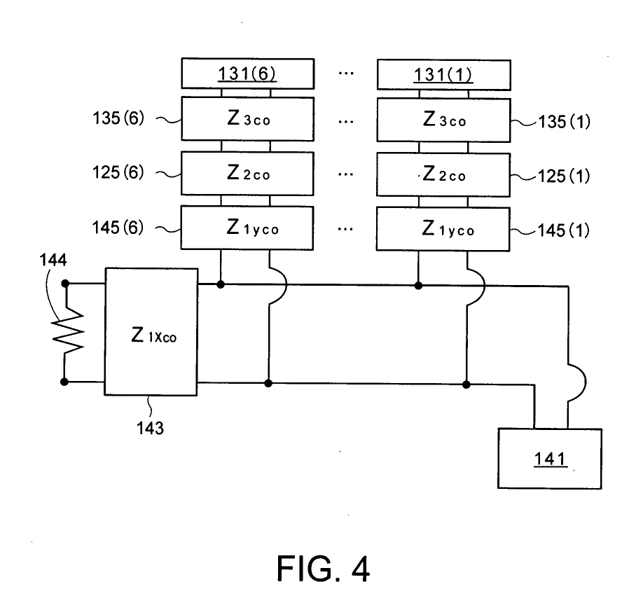

FIG. 4 represents an equivalent circuit model of the circuit board 100. In FIG. 4, a common mode impedance of the differential signal bus line 143 is Z_{1xco}, and a common mode impedance of the branch signal lines 145, 25 and 135 is respectively Z_{1yco}, Z_{2co} and Z_{3co}. In this case, in order to reduce field from the circuit board 100, the following expression (1) should be satisfied.

0.8×Z_{1yco}≦Z_{2co}≦1.2×Z_{1yco} (1)

The common mode impedance is an impedance in case that a common mode current flows on a pair of differential signal lines (the differential signal bus line 143 and the branch signal line 145). Furthermore, the differential impedance is an impedance in case that a differential mode current flows on a pair of differential signal lines. In general, reflection occurs at a boundary having discontinuous common mode impedance, and discontinuous element of the return current flows onto a ground (the ground electrode layer 117). In the first embodiment, by satisfying expression (1), reflection from a boundary between the branch signal line 145 and the branch signal line 125 reduces, and the return current flowing onto the ground electrode layer 117 becomes small. As a result, resonance in the circuit board 100 is suppressed and field from the circuit board 100 reduces.

### COMPARISON EXAMPLE

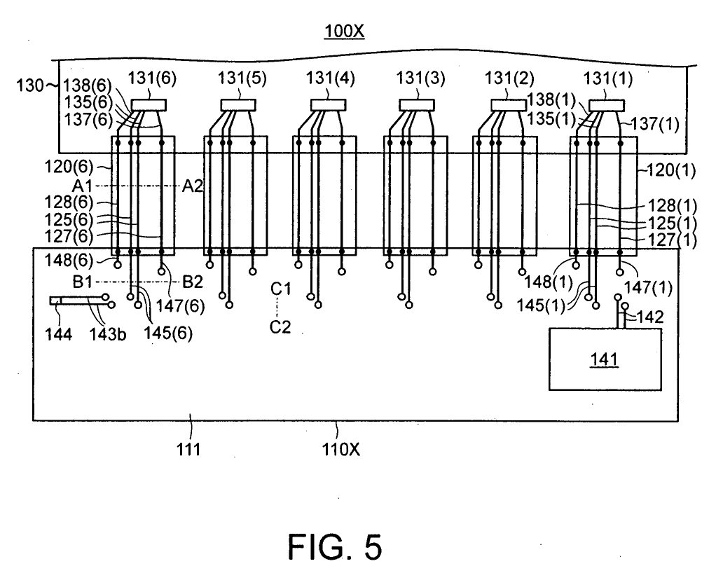

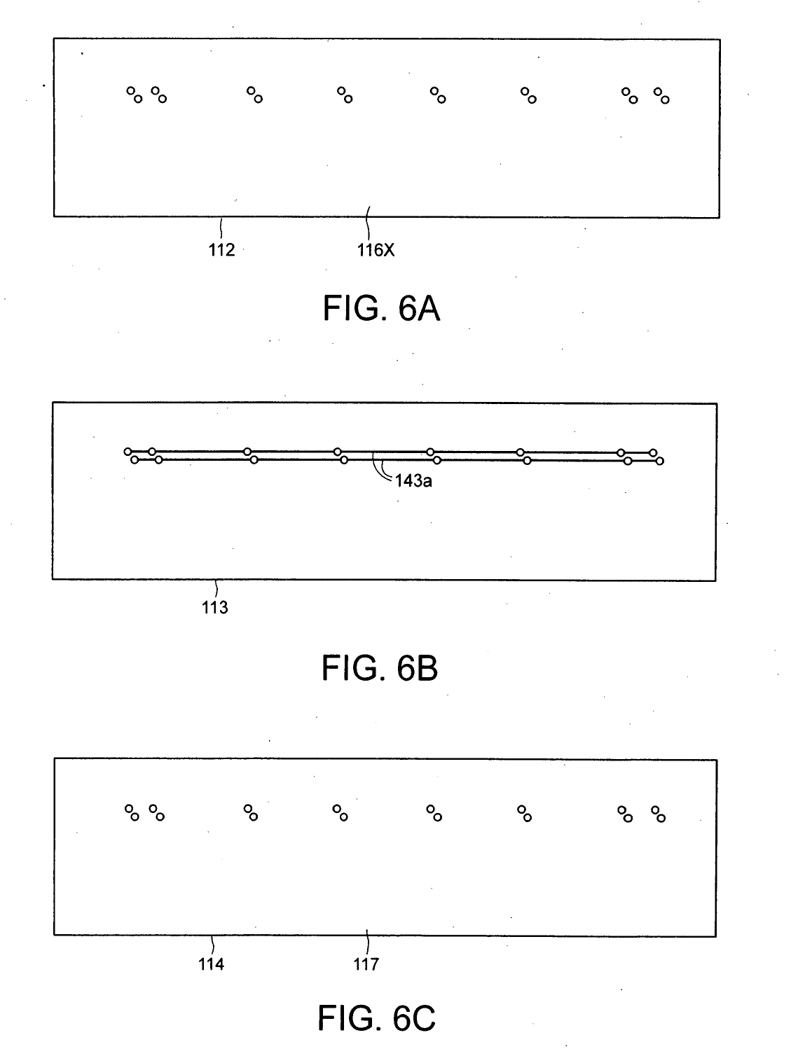

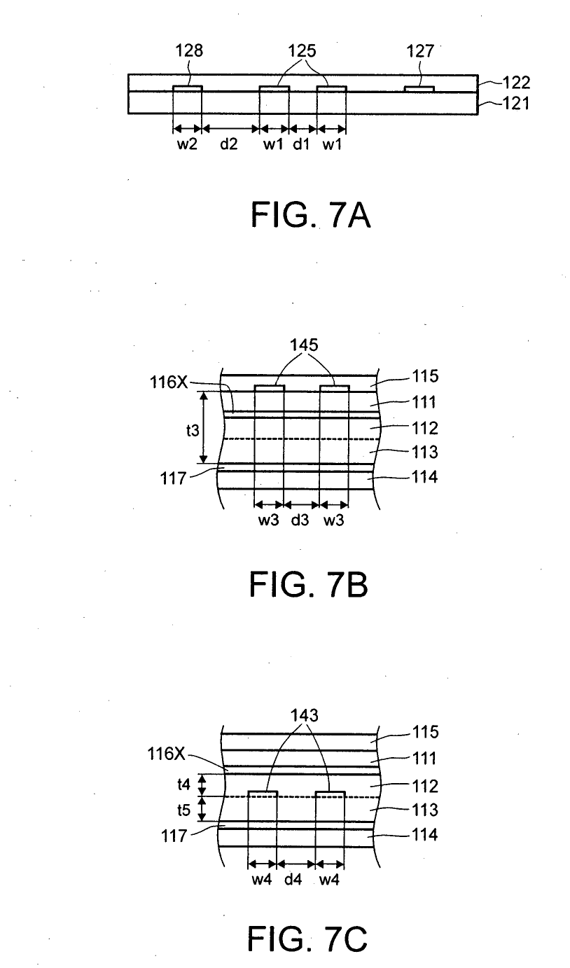

Hereinafter, utility of the first embodiment is explained by referring to a comparison example. FIG. 5 is a plan view of a circuit board 100X of a comparison example in correspondence with FIG. 1. FIGS. 6A˜6C are plan views of a second insulator layer 112˜a fourth insulator layer 114 of a first substrate 110X in correspondence with FIGS. 2A˜2C. FIGS. 7A˜7C are cross-sectional views which the circuit board 100X in FIG. 5 is cut along A1-A2, B1-B2, and C1-C2 in correspondence with FIGS. 3A˜3C.

The circuit board 100X includes a first substrate 110X, a second substrate 120 (120(1)˜120(N)), and a third substrate 130. As shown in FIGS. 7B and 7C, the circuit board 100X comprises four layers, a signal layer is disposed on the first and fourth layers, a power supply layer is disposed on the second layer, and a ground layer is disposed on the fourth layer. Especially, the power supply layer is all region of the second layer as shown in FIG. 6A. On the other hand, in the circuit board 100 of the first embodiment, a power supply layer is disposed on a part of the second layer as shown in FIG. 2A.

As mentioned-above, in the circuit board 100X, a power supply electrode layer (power supply face) 116X is directly disposed under the differential signal lines (the differential signal bus line 143 and the branch signal line 145). Except for this feature, the circuit board 100X is same as the circuit board 100 of the first embodiment. Accordingly, detail explanation is omitted.

In the differential impedance, a differential mode current flows between a pair of differential signal lines (the branch signal line 145), and a line of electric force closes between the pair of differential signal lines. As a result, disposition of the ground face (the ground electrode layer 117) does not affect. On the other hand, in the common mode impedance, a common mode current flows between a pair of differential signal lines (the branch signal line 145), and a line of electric force is generated between the differential signal line and the ground face (the ground electrode layer 117). As a result, the common mode impedance largely changes by a distance between the differential signal line and the ground face.

By simulator using the spectrum domain method, we calculate the differential impedance and the common mode impedance of the comparison example. For example, in FIG. 7A, width w1 of the branch signal line 125 is 100 μm, width w2 of the ground line 128 is 100 μm, a distance d1 between a pair of branch signal lines 125 is 110 μm, a distance d2 between the branch signal line 125 and the ground line 128 is 110 μm, and the insulator layer 121 is polyimide (relative permittivity ε=3.3). In this case, the differential impedance Z_{2df} is 144 Ω, and the common mode impedance Z_{2co} is 87 Ω.

In FIG. 7B, width w3 of the branch signal line 145 is 100 μm, a distance d3 between a pair of branch signal lines 145 is 100 μm, and a distance t3 along thick direction of the branch signal line 145 and the ground electrode layer 117 is 180 μm. In this case, the differential impedance Z_{1ydf} is 99 Ω, and the common mode impedance Z_{1yco} is 49 Ω.

In FIG. 7C, width w4 of the branch signal line 143 is 100 μm, a distance d4 between a pair of branch signal lines 143 is 100 μm, a distance t4 along thick direction of the branch signal line 143 and the ground electrode layer 116X is 180 μm, and a distance t5 along thick direction of the branch signal line 143 and the ground electrode layer 117 is 180 μm. In this case, the differential impedance Z_{1xdf} is 79 Ω, and the common mode impedance Z_{1xco} is 32 Ω.

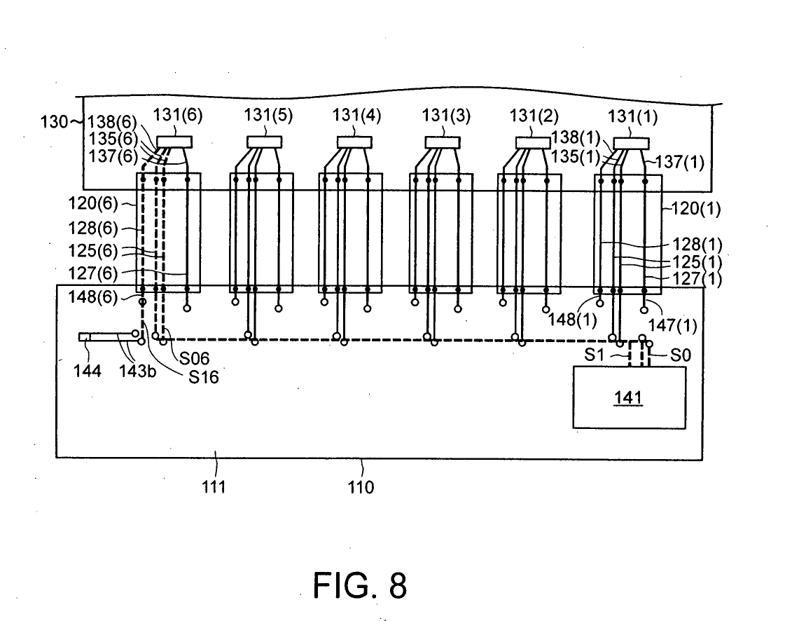

FIG. 8 is a plan view of the circuit board 100 of the present embodiment on which high frequency current is generated in the ground electrode layer 117 by discontinuity of common mode impedance. First, a general problem by discontinuity of common mode impedance is explained. A signal S0 from the driving-IC 141 is diverged by the branch signal line 145(6) as a signal S06. By reflecting the signal S06 between signal lines (the branch signal lines 145 and 125), a return current S16 is generated and flows to the ground line 128(6) and the ground electrode layer 117.

Briefly, if the common mode impedance Z_{1yco} of the first substrate 110 is different from the common mode impedance Z_{2co} of the second substrate 120, a signal is reflected at a boundary between these substrates 110 and 120. As a result, the return current flows on the ground line 128 of the second substrate 120 and the ground electrode layer 117 of the first substrate 110.

In the comparison example, the branch signal line 145 on the first insulator layer 111 overlaps with the power supply electrode layer 116X on the second insulator layer 112. The return current (generated by discontinuity of common mode impedance at the branch signal lines 145 and 124) flows onto the power supply electrode layer 116X. Accordingly, a current gradient along a horizontal direction is generated on the second insulator layer 112 (the power supply electrode layer 116X) and the fourth insulator layer 114 (the ground electrode layer 117) of the first substrate 110. The current gradient is generated on all six pairs of branch signal lines 145, and summed up. As a result, a large high frequency current flows on the power supply electrode layer 116X, and possibility that λ/4 resonance occurs on all the circuit board 100X is high.

### Comparison Between the First Embodiment and the Comparison Example

In the first embodiment, mechanism to reduce field is explained. In FIG. 3A, width w1 of the branch signal line 125 is 100 μm, width w2 of the ground line 128 is 100 μm, a distance d1 between a pair of branch signal lines 125 is 110 μm, a distance d2 between the branch signal line 125 and the ground line 128 is 110 μm, and the insulator layer 121 is polyimide (relative permittivity ε=3.3). In this case, the differential impedance Z_{2df} is 144 Ω, and the common mode impedance Z_{2co} is 87 Ω.

As shown in FIGS. 3B and 3C, the circuit board 100 comprises four insulator layers, a signal layer is disposed on the first and fourth insulator layers, a power supply layer is disposed on a part of the second insulator layer, and a ground layer is disposed on the fourth insulator layer. A part to dispose the power supply layer on the second insulator layer 112 of the circuit board 100 (the first embodiment) is different from entire part to dispose the power supply layer on the second insulator layer 112 of the circuit board 100X (the comparison example).

In FIG. 3B, width w3 of the branch signal line 145 is 100 μm, a distance d3 between a pair of branch signal lines 145 is 110 μm, and a distance t3 along thick direction of the branch signal line 145 and the ground electrode layer 117 is 180 μm. In this case, the differential impedance Z_{1ydf} is 105 Ω, and the common mode impedance Z_{1yco} is 82 Ω.

In FIG. 3C, width w4 of the branch signal line 143 is 100 μm, a distance d4 between a pair of branch signal lines 143 is 110 μm, and a distance t5 along thick direction of the branch signal line 143 and the ground electrode layer 117 is 180 μm. In this case, the differential impedance Z_{1xdf} is 79 Ω, and the common mode impedance Z_{1xco} is 43 Ω.

Briefly, the common mode impedance varies based on differences in line structure. In the first embodiment and the comparison example, disposition part of the power supply electrode layer 116 is different. Accordingly, the common mode impedances Z_{1yco} and Z_{1xco} are different between the first embodiment and the comparison example. In the first embodiment, a common mode impedance (FIG. 3B) of the branch signal line 145 on the first substrate 110 is near a common mode impedance (FIG. 3A) of the branch signal line 125 on the second substrate 120.

As mentioned above, the second substrate 120 does not include an electrode layer corresponding to the power supply electrode layer 116 and the ground electrode layer 117 of the first substrate (Especially, a conductive layer facing the branch signal line 125). In the first embodiment, the power supply electrode layer 116 is disposed on the second insulator layer 112 without overlapping the branch signal line 145 of the first insulator layer 145. As a result, in the first embodiment, by equaling decision elements of impedance of the first substrate and the second substrate (reduction of influence of the power supply electrode layer 116 and the ground electrode layer 117), a common mode impedance of the first substrate becomes near a common mode impedance of the second substrate.

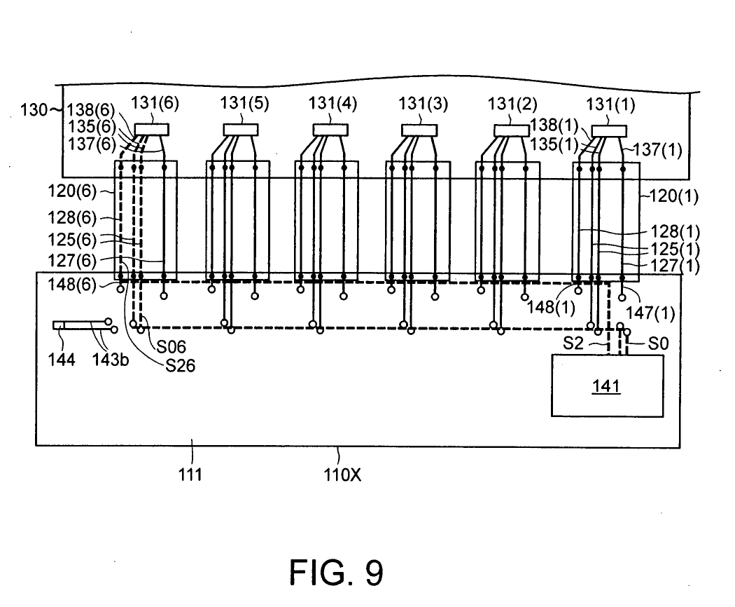

FIG. 9 is a plan view of the circuit board 110X of the comparison example on which high frequency current is generated on the ground electrode layer 117 by discontinuity of common mode impedance. In FIG. 9, the branch signal line 125, the ground line 128, and the branch power supply line 127 are laid in parallel on the second substrate 120. A return current is generated by unbalance of common mode impedance of the branch signal line 125, and flows into the ground line 128, because the second substrate 120 does not have a ground facing the branch signal line 125. A dotted line in FIG. 9 represents the return current.

Layer structure of the second substrate 120 is different from layer structure of the first substrate 110. Discontinuity of the differential impedance and the common mode impedance occurs at a boundary between the second substrate 120 and the first substrate 110X. In correspondence with a common mode current of the branch signal line 125 on the second substrate 120, a return current generated from discontinuity of common mode impedance flows onto the ground line 128 of the second substrate 120, and flows onto the ground electrode layer 117 of the first substrate 110X.

In correspondence with six pairs of branch signal lines 135(1)˜135(6), the common mode current flowing onto the ground electrode layer 117 exists an edge of a boundary part between the first substrate 110X and the second substrate 120, and almost-simultaneously generates at six branch part. The common mode current flows from a leading part of the ground line to the differential signal line. Accordingly, the common mode current is generated along the same horizontal direction as a direction of the differential signal bus line 143b. In FIG. 9, the common mode current is generated all together at a dotted line (represented by a horizontal edge line on the first substrate 110X) on the ground face. As a result, the ground current has a long path, and the common mode current affects the power supply face.

The common mode current is also generated by rise and fall of waveform at the differential signal bus line 143b. In this case, the power supply face (on the second insulator layer 112) and the ground face (on the fourth insulator layer 114) are stacked under (with overlapping) the differential signal bus line 143b (on the first insulator layer 111), and the return current flows onto the power supply face and the ground face. If discontinuity of common mode impedance occurs between the first substrate 110X and the second substrate 120, the current flows at an edge part and a center part on the power supply face and the ground face. As a result, a loop of large high frequency current flows, and causes a large unnecessary noise of electric magnetic field.

In FIG. 8, in the same way as in FIG. 9, the branch signal line 125, the ground line 128, and the branch power supply line 127 are laid in parallel on the second substrate 120. As mentioned above, the layer structure of the second substrate 120 is different from the layer structure of the first substrate 110. However, in the first embodiment, the common mode impedance of the second substrate 120 is almost equal to the common mode impedance of the first substrate 110. In this case, at a boundary between the second substrate 120 and the first substrate 110, a return current along horizontal direction at edge part (drawn in FIG. 9) is not generated in FIG. 8.

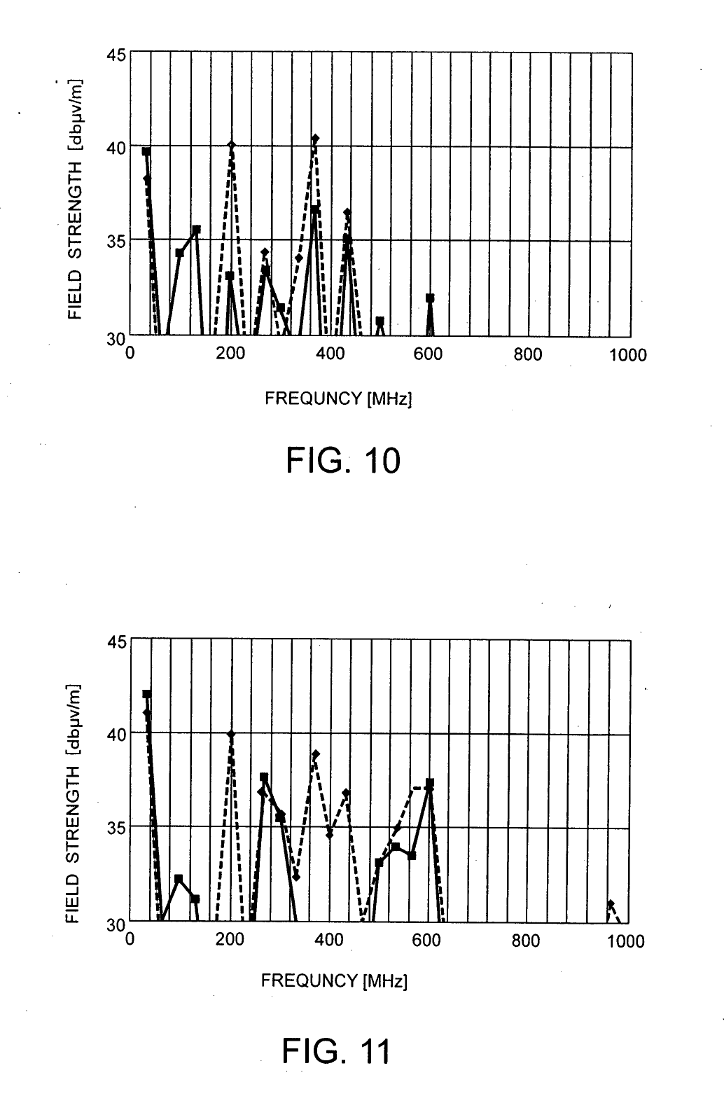

As shown in the first substrate 110 of FIG. 8, ground current flows in parallel with the differential signal bus line 143a, and continuously connects to a return current path of the ground face of the differential signal bus line 143b. In this case, a loop of high frequency current in FIG. 8 is smaller than the loop in FIG. 9. Accordingly, unnecessary noise of electric magnetic field reduces in FIG. 8. Especially, as shown in FIGS. 10 and 11 (explained afterwards), noise of electric magnetic field largely reduces at a resonance frequency 200 MHz (longitudinal direction of substrate is 4/λ).

In the first embodiment, reflection by discontinuous impedance between the branch signal lines 145 and 125 does not occur, and return current (high frequency current along horizontal direction) is not generated. In other words, at the differential signal bus line 143 along horizontal direction and the branch signal line 145 along vertical direction on the first substrate 110, high frequency current gradient along horizontal direction is not generated. Accordingly, resonance does not occur on the circuit board 100, and the field strength is reduced.

FIG. 10 and FIG. 11 respectively represent a graph of frequency dependency of horizontal element and vertical element of field strength according to the first embodiment and the comparison example. In FIGS. 10 and 11, a solid line represents the first embodiment, and a dotted line represents the comparison example. By comparing the solid line with the dotted line in FIGS. 10 and 11, in the first embodiment, the field strength of the horizontal direction and the vertical direction largely reduces at 200 MHz.

In the first embodiment and the comparison example, a length L0 of the first substrate 110 is 160 mm and a relative permittivity ε is 4.8. In this case, a resonance frequency f of λ/4 resonance is represented by the following expression (2).

$$\begin{matrix}f = V / λ \\ = ( 3 \times {10}^{8} / \sqrt{ } 4.8 ) / ( 0.16 \times 4 ) \\ = 214 MHz\end{matrix}$$

V: transmission speed of signal on line

λ: wavelength of the signal

As mentioned-above, in the first embodiment, when the length L0 of the first substrate 110 (the differential signal bus line 143) is λ/4 resonance is reduced. Neighborhood of 200 MHz corresponds to a six order harmonic of a clock frequency of the differential signal output from the driving-IC 141. In this way, reduction of field at a frequency band having harmonic element of low order (below ten order) as noise source is effective. To reduce λ/4 resonance, match the common mode impedance at the branch signal lines 145 and 125, especially at the end branch signal lines 145(6) and 125(6).

### First Modification

In a first embodiment, branch ratio 6:0 (a differential signal line source is disposed on an edge part of the circuit board) is explained. Briefly, the differential signal line 142 is connected to an edge part of the differential signal bus line 143a, and the differential signal bus line 143 (143a, 143b) and the differential signal line 142 compose a pair of differential signal lines as a whole. In this branch position 6:0, reflection quantity of signal is different by a branch position of the branch signal line 145. As a result, field strength along horizontal direction is apt to be large.

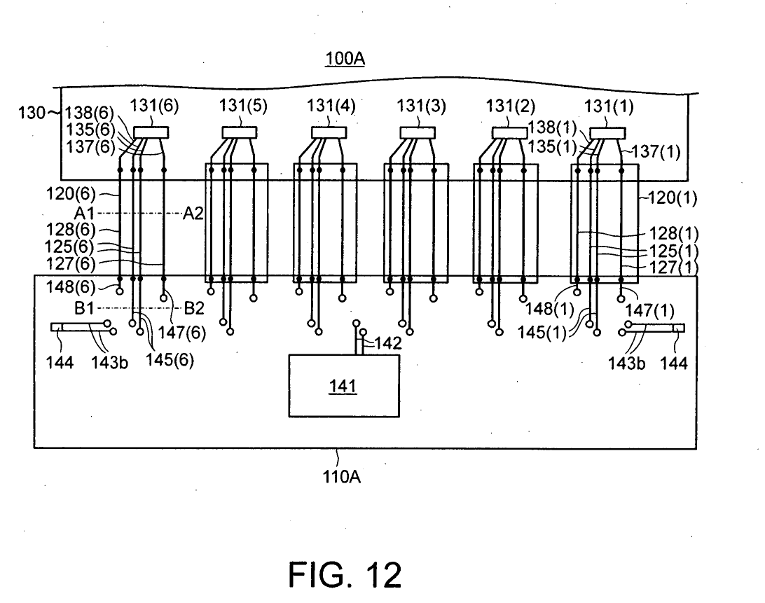

FIG. 12 is a plan view of a circuit board 100A according to a first modification of the first embodiment. In FIG. 12, a connection position of the differential signal line 142 to the differential signal bus line 143 is at a middle branch position of the branch signal line 145. This is called branch ratio 3:3 (a differential signal line source is disposed on a center part of the circuit board). In this case, as to connection position of the differential signal line 142, symmetry of branch position of the branch signal line 145 is high. Even if a signal is reflected at each branch position, reflection from the right and left are cancelled, and field strength along horizontal direction becomes small. Accordingly, in comparison with the branch ratio 6:0, λ/4 resonance is hard to occur, and field strength at low frequency side is suppressed.

A method for reducing field strength by matching the common mode impedance of the branch signal lines 145 and 125 is effective for any of branch ratios 6:0, 5:1, 4:2, 3:3. In general, branch ratio N:0, (N-1):1, . . . , (N-k):k, . . . , N/2:N/2, . . . 0:N, are applied.

### Second Modification

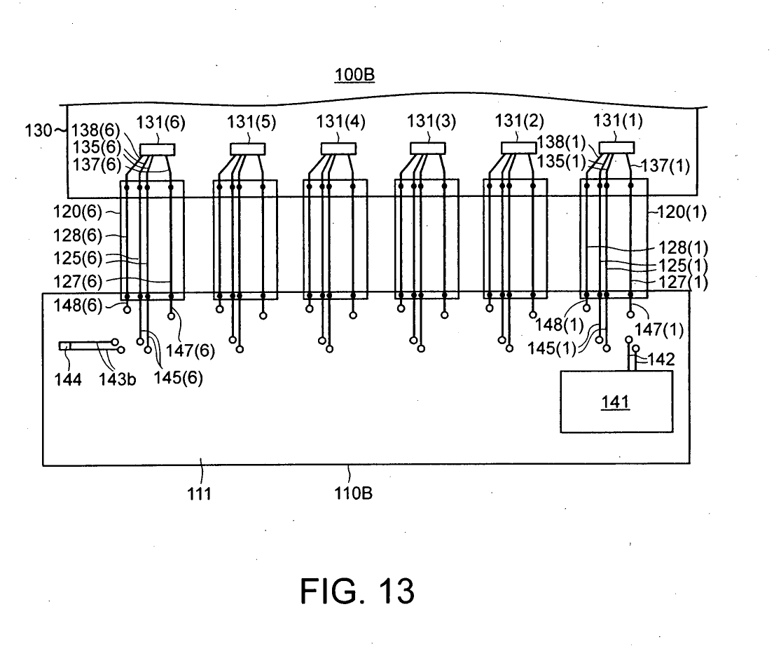

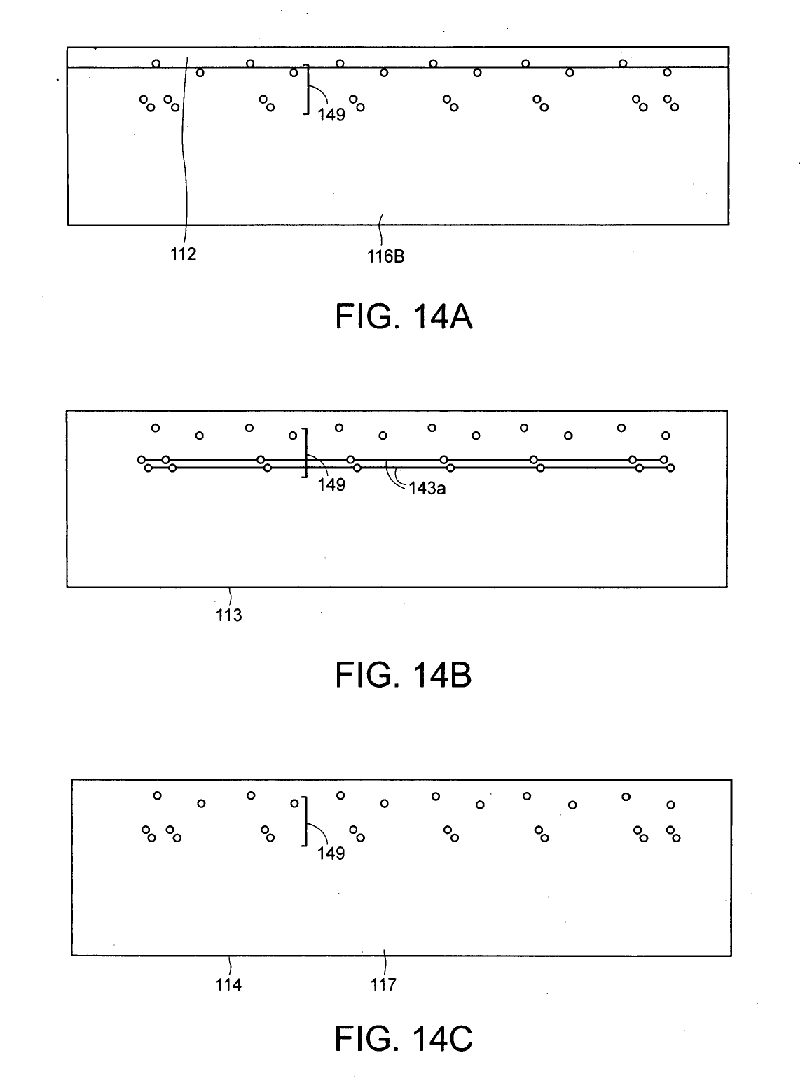

FIG. 13 is a plan view of a circuit board 100B according to a second modification of the first embodiment. FIGS. 14A˜14C are plans of a second insulator layer 112˜a fourth insulator layer 114 of the first substrate 110B in correspondence with FIGS. 2A˜2C. In the second modification, a power supply electrode layer 116B is disposed on the second insulator layer 112 without overlapping the ground line 148 of the first insulator layer 111. The power supply electrode layer 116B is disposed on the second insulator layer 112 overlapping the differential signal bus line 143a of the third insulator layer 113. Furthermore, a power supply line 146 of the first embodiment is omitted. A branch power supply line 147 is directly connected to the power supply electrode layer 116B.

Next, FIGS. 14A˜14C are explained in detail. The differential line often includes not only clock lines but data lines, and several pairs of differential lines are often disposed on the first substrate 110. In this case, if a power supply layer is not disposed between the differential signal bus line 143a and the branch signal line 145, a coupling between these lines and cross talk occur. This cross talk becomes noise source of signal lines 149 as cause of EMI. As shown in FIG. 14A, by disposing the power supply electrode layer 116B between the differential signal bus line 143b and the branch signal line 145(6), the coupling is eliminated and the cross talk can be reduced.

However, in the second modification, the power supply electrode layer 116B is disposed on the second insulator layer 112 without overlapping the ground line 148, and discontinuity of common mode impedance between the first substrate 110B and the second substrate 120 is eliminated. Accordingly, return current along horizontal direction on the ground face (by impedance discontinuity at substrate edge) can be reduced.

As to the power supply from the first substrate 110B to the third substrate 130, compare the power supply layer in FIG. 14A with the power supply in FIG. 2A. In FIG. 14A, the power supply is nearer an edge part of the first substrate 110 than the power supply of FIG. 2A, and does not cross the differential signal bus line 143b. Accordingly, the power can be supplied from the power supply electrode layer 116B via a hole through the branch power supply line 127 of the second substrate 120.

In the first embodiment, the power supply electrode layer 116 is disposed on the second insulator layer 112 without overlapping the differential signal bus line 143 and the branch signal line 145. In this case, transmission noise may occur by interference between the differential signal bus line 143 and the branch signal line 145. However, in the second modification, the power supply electrode layer 116B is disposed on the second insulator layer 112 overlapping the differential signal bus line 143 and the branch signal line 145. Accordingly, the interference between the differential signal bus line 143 and the branch signal line 145 is reduced, and λ/4 resonance by increase of high frequency current on the edge part of the first substrate 110B is reduced.

### Second Embodiment

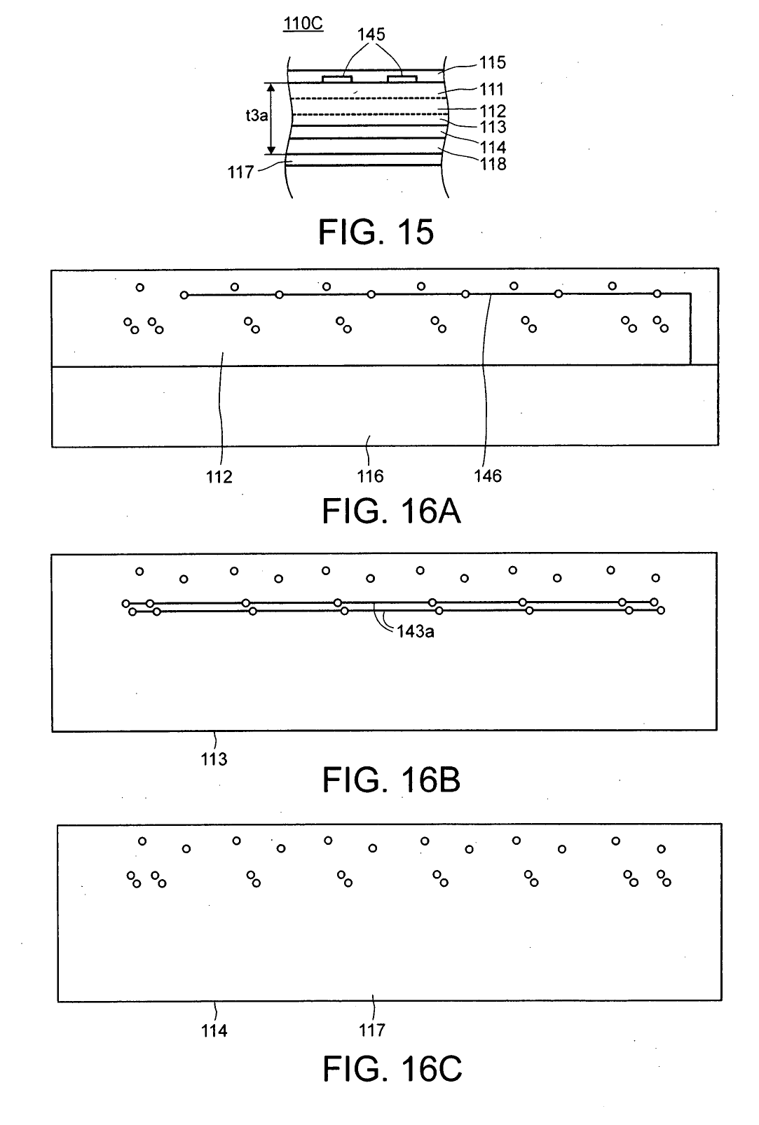

Next, a second embodiment is explained. FIG. 15 is a section of a first substrate 110C of a circuit board 100C according to the second embodiment. FIGS. 16A˜16C are plan views of a second insulator layer 112 through a fourth insulator layer 114 of the first substrate 110C. In the second embodiment, the ground electrode layer 117 is disposed on the most outer layer of the first substrate 110C, and a fifth insulator layer (dielectric) 118 is disposed between the fourth insulator layer 114 and the ground electrode layer 117.

The ground electrode layer 117 is disposed as the most outer layer of the first substrate 110C. Accordingly, the ground electrode layer 117 functions as a sealing layer to protect the first substrate 110C from outside noise. Furthermore, disposing the fifth insulator layer (dielectric) 118 between the fourth insulator layer 114 and the ground electrode layer 117 lengthens the a distance t3a between the branch signal line 145 and the ground electrode layer 117. As a result, common mode impedance Z_{1yco} of the branch signal line 145 increases, and condition of the expression (1) is easily satisfied.

In the first embodiment, the power supply electrode layer 116 is disposed on the second insulator layer 112 without overlapping the branch signal line 145, and the ground electrode layer 117 is disposed as a layer most distant from the branch signal line 145. As a result, common mode impedance Z_{1yco} of the branch signal line 145 is nearly equal to common mode impedance Z_{2co} of the branch signal line 125.

However, if the first substrate 110 is thin, even if the ground electrode layer 117 is disposed as the most outer layer of the first substrate 110, matching the impedance may be insufficient. Briefly, common mode impedance Z_{1yco} of the branch signal line 145 is smaller than common mode impedance Z_{2co} of the branch signal line 125. On the other hand, in the second embodiment, by disposing the ground electrode layer 117 at an outer position thicker than a thickness of accomplished first substrate, the expression (1) can be satisfied.

### Third Embodiment

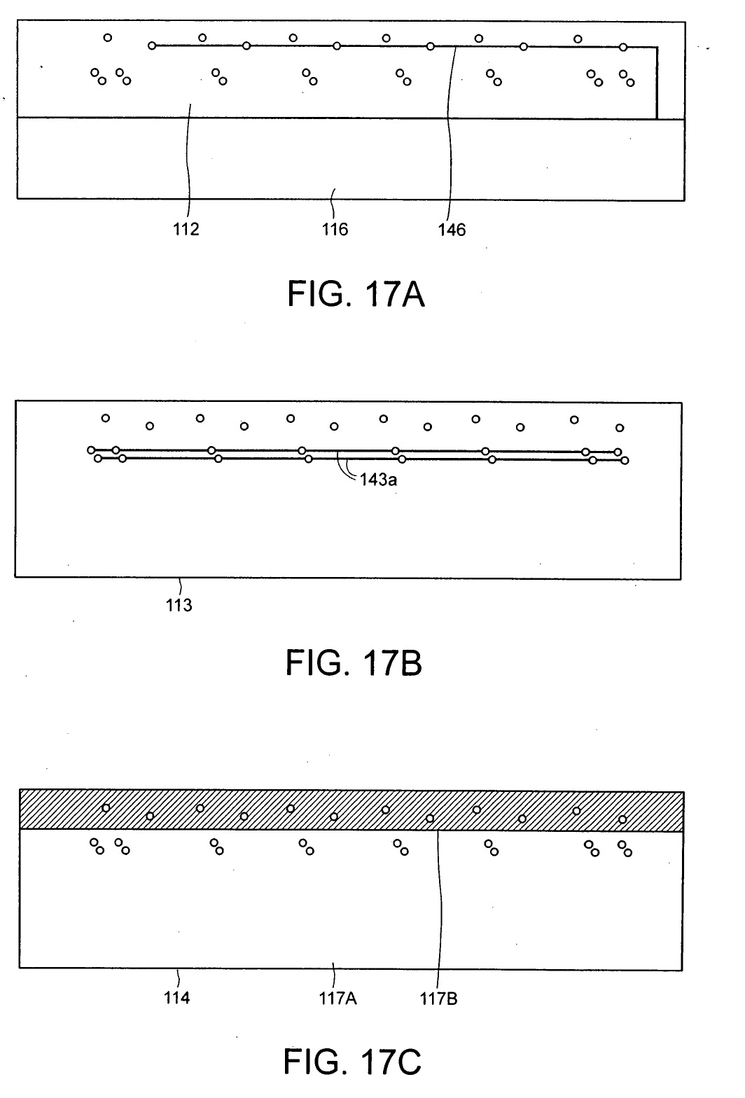

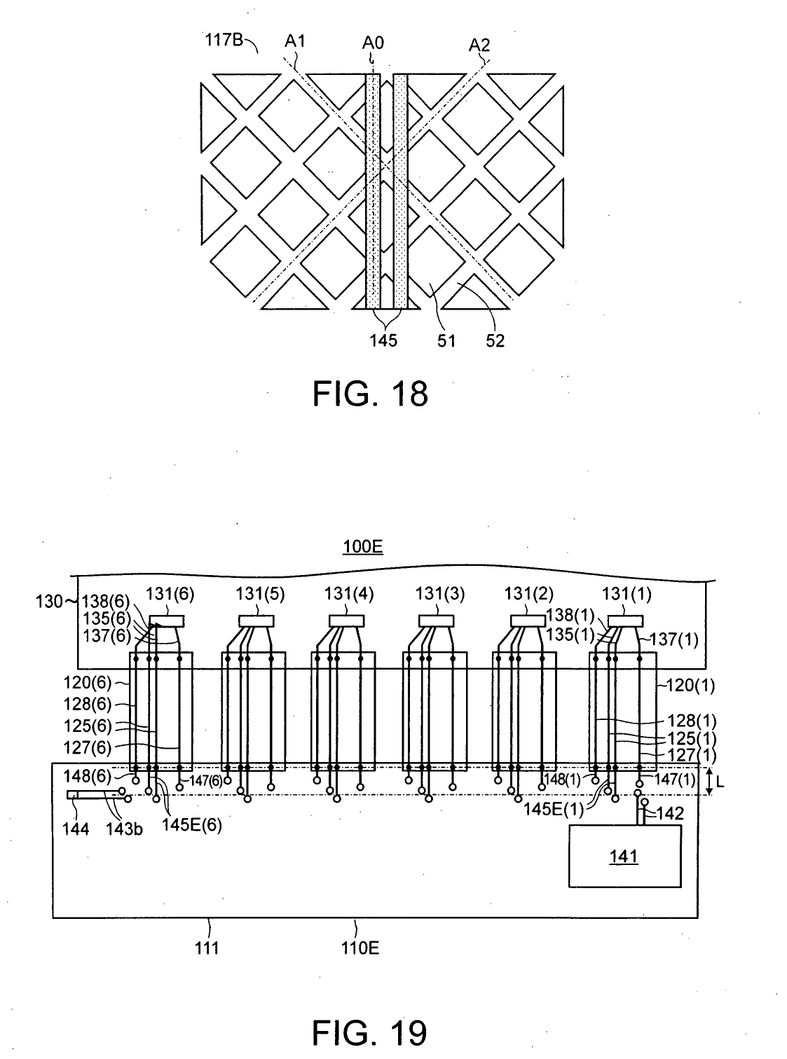

Next, a third embodiment is explained. FIGS. 17A˜17C are plan views of a second insulator layer 112 through a fourth insulator layer 114 of a first substrate 110D of a circuit board 100D according to the third embodiment. FIG. 18 is a plan of a meshed ground electrode layer 117B compared with the branch signal line 145. An upper face of the circuit board 100D is same as the first embodiment in FIG. 1. Accordingly, drawing of the upper face is omitted.

In the third embodiment, the ground electrode layer is divided into two regions (non-meshed ground electrode layer 117A and meshed ground electrode layer 117B). The meshed ground electrode layer 117B overlaps the branch signal line 145. By meshing at least one part of the ground electrode layer, common mode impedance Z_{1yco} of the branch signal line 145 is adjusted.

The meshed ground electrode layer 117B includes an opening part 51 and a conductive part 52. Briefly, by setting a plurality of opening parts 51, the ground electrode layer is meshed. On the other hand, the conductive part 52 is regarded as cross part of lines along two directions A1 and A2. Briefly, on the conductive part 52, current along two directions A1 and A2 each different from a direction A0 of the branch signal line 145 can flow. In other words, on the meshed ground electrode layer 117B restricts current flow along the direction A0 of the branch signal line 145. By setting a plurality of opening parts 51 along directions A1 and A2 different from the direction A0 of the branch signal line 145, line directions A1 and A2 of the conductive part 52 is realized.

A method of the third embodiment is effective to a case that common mode impedance Z_{1yco} of the branch signal line 145 does not satisfy the expression (1) even if the ground electrode layer is disposed as an outer layer most distant from the branch signal line 145. If common mode impedance Z_{1yco} of the branch signal line 145 is too much larger than common mode impedance Z_{2co} of the branch signal line 125, by disposing the ground electrode layer 117 as inner layer of the first substrate 110, common mode impedance Z_{1yco} can be reduced.

On the other hand, increase of common mode impedance Z_{1yco} is realized by prolongation of the distance between the branch signal line 145 and the ground electrode layer 117 or meshing of the ground electrode layer 117. The common mode impedance Z_{1yco} of the meshed ground electrode layer 117B is an average value of the conductive part 52 and the opening part 51. Accordingly, by adjusting a width between lines (line pitch) of the conductive part on the meshed ground electrode layer 117B, the common mode impedance Z_{1yco} can be suitably set. In this case, it is desirable that line directions A1 and A2 on the meshed ground electrode layer 117B are different from line direction A0 of the branch signal line 145 (Each rectangle formed by two directions A1 and A2 is a lozenge for the line direction A0). For example, an angle between the line directions A0 and A1, and an angle between the line directions A0 and A2 are respectively 45°. As a result, wraparound of return current onto the ground face can be reduced.

### Fourth Embodiment

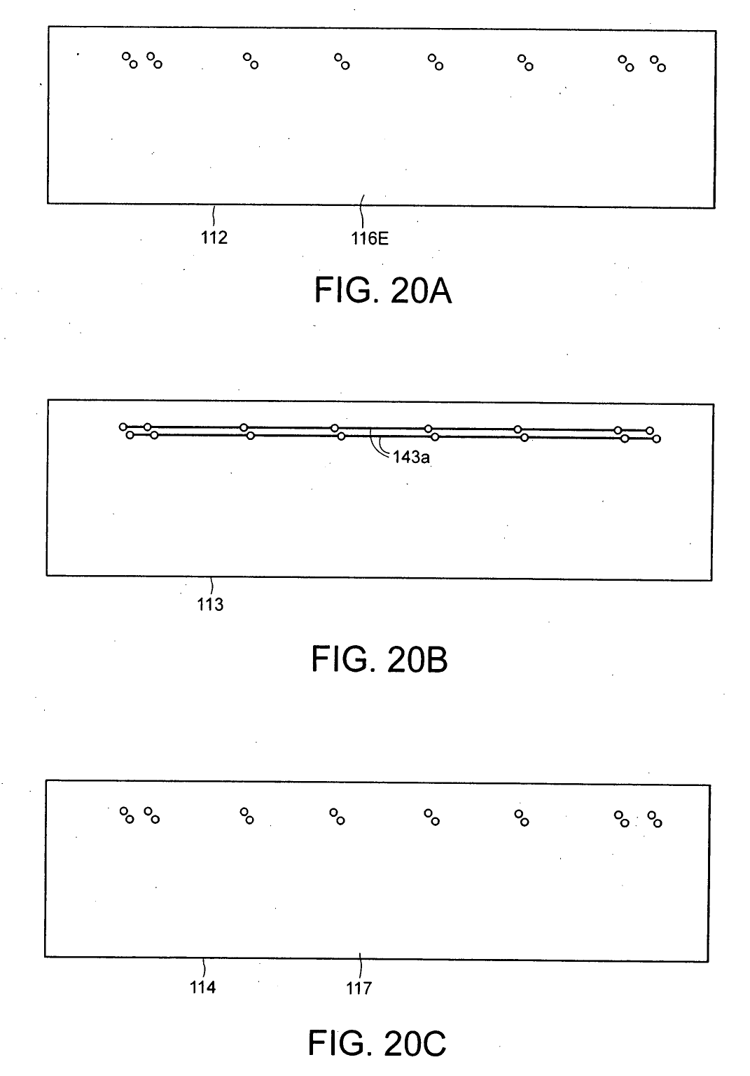

Next, a fourth embodiment is explained. FIG. 19 is a plan of a circuit board 100E according to the fourth embodiment. FIGS. 20A˜20C are plans of a second insulator layer 112 through a fourth insulator layer 114 of the first substrate 110E in correspondence with FIGS. 2A˜2C.

In the fourth embodiment, two aspects are different compared with the first embodiment in FIG. 1. First, a line length L of the branch signal line 145E on the first substrate 110E is short. In other words, the differential signal line 143b is laid near an edge part of the first substrate 110E. Second, as shown in FIG. 20A, the power supply electrode layer 116E is disposed on entire region of the second insulator layer 112.

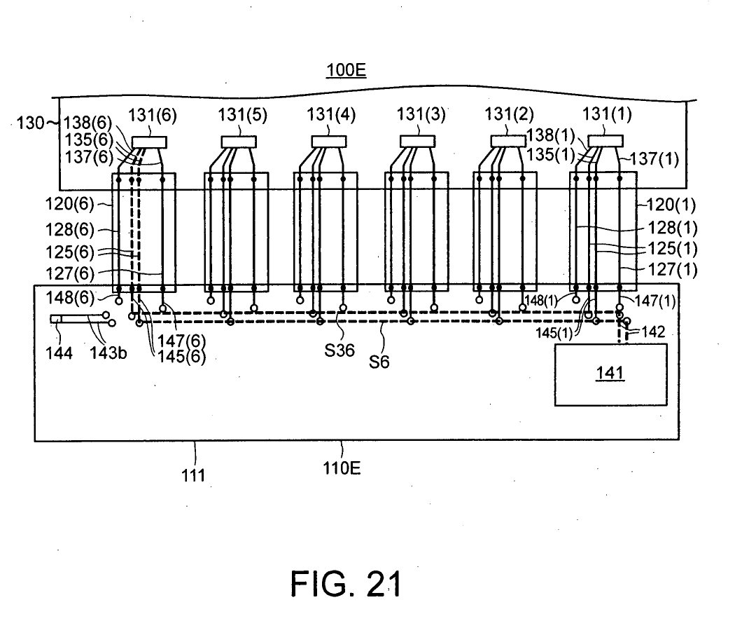

Flow of return current is explained by referring to FIG. 21. As shown in FIG. 21, current S36 along a horizontal direction flows on the edge part of the first substrate 110E by discontinuity of common mode impedance between the first substrate 110E and the second substrate 120. If an unbalance in the rise and fall of a signal on the differential signal bus line 143 generates a common mode current, the return current flows on the ground face directly under the differential signal bus line 143.

In the fourth embodiment, a distance L between the edge of the first substrate 110E and the differential signal bus line 143 is shortened. In this case, a position of current generated by non-coincidence of common mode impedance at the edge part is nearly matched with a position of current originally flowing under the differential signal bus line 143. As result, a loop area of high frequency current along the horizontal direction is reduced. As to a smaller one of the high frequency current loop, resonance frequency is converted to high frequency, and the field strength becomes small.

As to the distance L between the edge part and the differential signal bus line 143, the distance L is determined so that the ground face sufficiently covers at least distribution area of electro-magnetic field by the differential signal bus line 143. For example, the differential signal bus line 143 may be disposed at a position spaced from the edge part over five times the space between the pair of differential signal bus line 143.

As mentioned-above, in the present embodiments, reflection by discontinuity of common mode impedance is reduced in order to reduce unnecessary field noise. Especially, by reducing signal-reflection at edge part of the first substrate 110, high frequency-current gradient at edge part of the ground face 117 is suppressed. As a result, resonance on the first substrate 110 and unnecessary field noise are reduced.

By matching common mode impedance of the branch signal lines 145, 125, 135 and the receiver IC 131, signal-reflection is suppressed. However, at input part of the receiver IC 131, matching of common mode impedance (including a pad part and input capacity) is difficult. If signal-reflection occurs at the input part of the receiver IC 131, resonance may occur on all line length of the differential signal line 142, the differential signal bus line 143, the branch signal lines 145, 125 and 135. Furthermore, if this resonance frequency is within ten orders of the clock frequency of the differential signal from the driving-IC 141, field-radiation from the circuit board 100 may increase. In this case, resonance of minimum order is regarded as λ/2 that current is the maximum at the driving-IC 141 and the minimum at the receiver IC 131.

The branch ratio 3:3 in FIG. 12 is effective in the case that line length of the branch signal line 145 is long and the resonance frequency is relatively low. Furthermore, even if line length of the branch signal line 145 is short, the branch ratio 6:0 in FIG. 1 is effective in the case that a distance between the driving IC 141 and the receiver IC 131 (most distant from the driving IC 141 in six receiver ICs 131) is long and the resonance frequency is relatively low.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A circuit board comprising a first substrate, a second substrate, and a third substrate;
the first substrate comprising:
a transmitter IC supplying a pair of differential signals;
a pair of bus lines each having a connection to receive the pair of differential signals;
a terminating register electrically connected to one end of the pair of bus lines; and
N pairs of first branch lines, each of the N pairs of first branch lines being branched from the pair of bus lines;
the second substrate comprising:
N pairs of second branch lines, each of the N pairs of second branch lines electrically connected to each of the N pairs of first branch lines; and
the third substrate comprising:
N units of receiver ICs, each of the N units of receiver ICs electrically connected to each of the N pairs of second branch lines;
wherein relationship between a common mode impedance Z1 of the first branch lines and a common mode impedance Z2 of the second branch lines is 0.8·Z1≦Z2≦1.2·Z1.

2. The circuit board according to claim 1, wherein
the first substrate includes a first insulator layer and a second insulator layer each stacked, and
the N pairs of first branch lines are disposed on the first insulator layer,
further comprising:
a power supply layer disposed on a region of the second insulator layer, the region not overlapping the N pairs of first branch lines on the first insulator layer.

3. The circuit board according to claim 2, further comprising:
a power supply line disposed on the second insulator layer, the power supply line electrically connecting to the power supply layer; and
N first branch power supply lines disposed on the first substrate, each of the N first branch power supply lines being electrically branched from the power supply line.

4. The circuit board according to claim 2, wherein
the first substrate includes a third insulator layer and a fourth insulator layer each stacked with the first insulator layer and the second insulator layer, and
the pair of bus lines is disposed on the third insulator layer,
further comprising:
a ground layer disposed on the fourth insulator layer.

5. The circuit board according to claim 4, wherein
the region of the second insulator layer does not overlap the pair of bus lines on the third insulator layer.

6. The circuit board according to claim 5, further comprising:
N first ground lines disposed on the first insulator layer, each of the N first ground lines electrically connecting to the ground layer on the fourth insulator layer.

7. The circuit board according to claim 1, wherein
the second substrate does not have a conductive layer facing the N pairs of second branch lines.

8. The circuit board according to claim 3, further comprising:
N second branch power supply lines disposed on the second substrate, each of the N second branch power supply lines having one end electrically connecting to each of the N first branch power supply lines and the other end electrically connecting to each of the N units of receiver ICs.

9. The circuit board according to claim 6, further comprising:
N second ground lines disposed on the second substrate, each of the N second ground lines having one end electrically connecting to each of the N first ground lines and the other end electrically connecting to each of the N units of receiver ICs.

10. The circuit board according to claim 1, wherein
the transmitter IC is disposed on an end part of the first insulator layer to the N pairs of first branch lines.

11. The circuit board according to claim 1, wherein
the transmitter IC is disposed on a center part of the first insulator layer to the N pairs of first branch lines.

12. The circuit according to claim 11, further comprising:
another terminating register electrically connected to the other ends of the pair of bus lines on the first insulator layer.

13. The circuit board according to claim 6, wherein
the region of the second insulator layer does not overlap at least the N first ground lines on the first insulator layer.

14. The circuit board according to claim 1, wherein
the first substrate includes a plurality of insulator layers each stacked,
further comprising:
a ground layer disposed on the most outer surface of the plurality of insulator layers.

15. The circuit board according to claim 4, wherein
the ground layer includes a meshed region overlapped with the N pairs of first branch lines on the first insulator layer.

16. The circuit board according to claim 15, wherein
the meshed region includes a plurality of opening parts each arranged along a predetermined direction different from a line direction of the N pairs of first branch lines.

17. The circuit board according to claim 16, wherein
an angle between the predetermined direction and the line direction is approximately 45°.

18. The circuit board according to claim 2, wherein
the pair of bus lines is disposed at a position spaced from an edge of the first substrate at least five times greater than the space between the pair of bus lines.

19. The circuit board according to claim 18, wherein
a line length of the N pairs of first branch lines is at least five times greater than the space between the pair of bus lines.

20. The circuit board according to claim 18, wherein
the power supply layer is disposed on all region of the second insulator layer.
